(19) United States
(12) Patent Application Publication
(10) Pub. No.: US 2023/0180128 A1
(43) Pub. Date: Jun. 8, 2023

(54) VALUATION FOR UE ASSISTANCE INFORMATION

(71) Applicant: ZTE Corporation, Shenzhen (CN)

(72) Inventors: Jianmin FANG, Shenzhen (CN); He HUANG, Shenzhen (CN); Zhihong QIU, Shenzhen (CN)

(21) Appl. No.: 18/164,915

(22) Filed: Feb. 6, 2023

Related U.S. Application Data
(63) Continuation of application No. PCT/CN2020/107436, filed on Aug. 6, 2020.

(51) Int. Cl. H04W 52/02; H04W 76/28

(52) U.S. Cl. CPC H04W 52/0216; H04W 76/28; H04W 52/0277

(57) ABSTRACT

The present document relates to methods, systems, and devices related to digital wireless communication, and more specifically, to techniques related to valuation of UE assistance information. In one exemplary aspect, a method for data communication is disclosed. The method includes transmitting, by a network node, a first message including a set of configuration information to a terminal. The method also includes receiving, by the network node, a second message from the terminal, the second message including a set of reporting information according to the set of configuration information. The method also includes comparing, by the network node, the set of reporting information with a set of assistance information received from the terminal to determine whether the set of assistance information corresponds to the set of reporting information.

### CROSS-REFERENCE TO RELATED APPLICATION

This application is a continuation and claims priority to International Application No. PCT/CN2020/107436, filed on Aug. 6, 2020, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, are being discussed.

### SUMMARY

This document discloses methods, systems, and devices related to digital wireless communication, and more specifically, to techniques related to valuation of UE assistance information.

In one exemplary aspect, a method for data communication is disclosed. The method includes transmitting, by a network node, a first message including a set of configuration information to a terminal. The method also includes receiving, by the network node, a second message from the terminal, the second message including a set of reporting information according to the set of configuration information. The method also includes comparing, by the network node, the set of reporting information with a set of assistance information received from the terminal to determine whether the set of assistance information corresponds to the set of reporting information.

In one exemplary aspect, a method for data communication is disclosed. The method includes transmitting, by a network node, a first message including a set of configuration information to a terminal. The method also includes receiving, by the network node, a second message from the terminal, the second message including a set of reporting information according to the set of configuration information. The method also includes deriving, by the network node, a minimization of driving test (MDT) measurement based on the set of reporting information.

In another exemplary aspect, a wireless communications apparatus comprising a processor is disclosed. The processor is configured to implement a method described herein.

In yet another exemplary aspect, the various techniques described herein may be embodied as processor-executable code and stored on a computer-readable program medium.

The details of one or more implementations are set forth in the accompanying attachments, the drawings, and the description below. Other features will be apparent from the description and drawings, and from the clauses.

### BRIEF DESCRIPTION OF THE DRAWINGS

FIG. 1 is an illustration of an example 5G network architecture.

FIG. 2 illustrates an example signaling process for UE assistance information reporting.

FIG. 3 is a signaling process for valuating UE assistance information according to a first example embodiment.

FIG. 4 is a signaling process for valuating UE assistance information according to a second example embodiment.

FIG. 5 is a signaling process for valuating UE assistance information according to a third example embodiment.

FIG. 6 is a signaling process for valuating UE assistance information according to a fourth example embodiment.

FIG. 7 is a signaling process for valuating UE assistance information according to a fifth example embodiment.

FIG. 8 is a signaling process for valuating UE assistance information according to a sixth example embodiment.

FIG. 9 is a signaling process for valuating UE assistance information according to a seventh example embodiment.

FIG. 10 is a block diagram of an example method for valuation of UE assistance information.

FIG. 11 shows an example of a wireless communication system where techniques in accordance with one or more embodiments of the present technology can be applied.

FIG. 12 is a block diagram representation of a portion of a hardware platform.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

The development of the new generation of wireless communication—5G New Radio (NR) communication—is a part of a continuous mobile broadband evolution process to meet the requirements of increasing network demand. NR will provide greater throughput to allow more users connected at the same time. Other aspects, such as energy consumption, device cost, spectral efficiency, and latency are also important to meeting the needs of various communication scenarios.

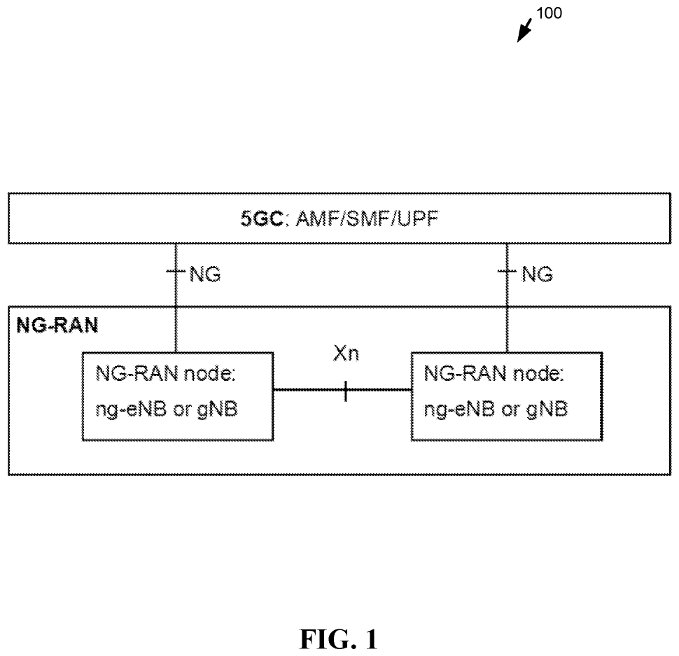

FIG. 1 illustrates an example 5G network architecture 100. As shown in FIG. 1, a fifth generation (5G) network architecture may include a 5G core network (5GC) and a next generation radio access network (NG-RAN). The 5GC may include any of an Access Mobility Function (AMF), a Session Management Function (SMF), and a User Plane Function (UPF). The NG-RAN may include base stations with different radio access technologies (RATs), such as an evolved 4G base station (ng-eNB), a 5G base station (gNB). The NG-RAN base station may be connected to the 5GC through the NG interface, and the NG-RAN base stations may be connected through the Xn interface.

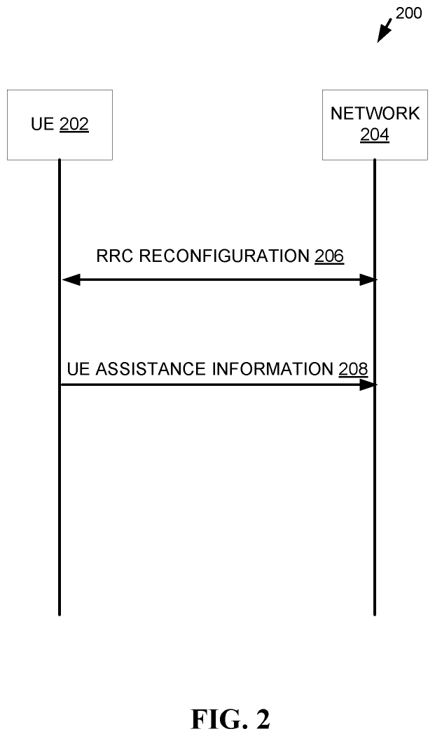

FIG. 2 illustrates an example signaling process for user equipment (UE) assistance information reporting 200. The purpose of this procedure is for the UE to inform the network of assistance information for power saving, or dealing with overheating, in-device coexistence (IDC) problem, etc. In FIG. 2, a network node 204 can send an RRC reconfiguration message 206 to the UE 202. The UE 202 can send UE assistance information 208 to the network node 204.

However, the UE may report the UE assistance information more aggressive or on the opposite under certain considerations. For example, the UE may report that its preference on the maximum number of secondary component carriers is 0 (i.e. disable the carrier aggregation), to achieve the advertising of super long battery life time. As another example, the UE may report that its preference on the maximum number of secondary component carriers is the max number of secondary serving cells, to achieve the advertising of super high throughput performance.

### System Overview

The present embodiments can relate to valuation of UE assistance information. This can assist with the network to evaluate whether the UE assistance information reported from UE is too aggressive or on the opposite.

A UE can report a first reporting information message to a network. The first reporting information message can include at least one of: an average scheduling interval including both downlink and uplink, an average downlink scheduling interval, an average uplink scheduling interval, a number of physical downlink control channel (PDCCH) reception per discontinuous reception (DRX) cycle or per configured period, an average percentage of active time in a DRX cycle, a number of continuous DRX cycle with percentage of active time above configured threshold, a number of DRX cycle with percentage of active time above configured threshold within configured period, a current temperature of the UE, a predicted holding time (the UE may have severe problem after this holding time, if the UE's temperature is not decreased), a severity of in-device coexistence (IDC) problem, an interference measurement result related to IDC problem, a predicted throughput, a predicted delay requirement, a predicted time duration the UE will not send or receive data, a predicted remaining battery working time if the UE's preference will be adopted by the network, a predicted remaining battery working time if the UE's preference will not be adopted by the network, a remaining battery working time, a percentage of remaining battery working time, a level of remaining battery working time, for example high-medium-low, another example index 1, 2, . . . , 10 represents 10%, 20%, . . . , 100%, an estimated whole battery working time after 100% recharged, an average recharging interval of the UE, a percentage of time that remaining battery working time is less than a configured threshold, UE capability information, UE category, UE type, e.g. normal UE, industry sensor, video surveillance, wearable device, a periodical measurement result per cross link interference-received signal strength indication (CLI-RSSI) resource and CLI-RSSI resource index, a periodical reference signal received power (RSRP) measurement result per sounding reference signal (SRS) resource and SRS resource index, an event triggered measurement result per CLI-RSSI resource and CLI-RSSI resource index, for example event I1 (interference becomes higher than threshold) triggered, and an event triggered RSRP measurement result per SRS resource and SRS resource index, for example event I1 (interference becomes higher than threshold) triggered.

The network can evaluate information and/or the preference included in the UE assistance information message received from the UE with a comprehensive comparison of the first reporting information. Alternatively, the first reporting information can be used for a minimization of driving test (MDT) purpose (i.e. the first reporting information is or is partial of the MDT measurement result). Alternatively, the first reporting information can be used for a self-optimizing network (SON) purpose.

The first reporting information can be included in the existing UE assistance information message, the existing UE information response message, the existing measurement report message, or a new message. The network can send a first configuration information to the UE, the UE reports the first reporting information according to the received first configuration information.

The first configuration information can include at least one of: information to request reporting the average scheduling interval including both downlink and uplink, information to request reporting the average downlink scheduling interval, information to request reporting the average uplink scheduling interval, information to request reporting the number of PDCCH reception per DRX cycle or per configured period, a configured period used to calculate the number of PDCCH reception per the configured period, information to request reporting the average percentage of active time in a DRX cycle, information to request reporting the number of continuous DRX cycle with percentage of active time above configured threshold, and/or a configured threshold used to calculate the number of continuous DRX cycle with percentage of active time above the configured threshold.

The first configuration information can include at least one of: information to request reporting the number of DRX cycle with percentage of active time above configured threshold within configured period, a configured threshold and a configured period used to calculate the number of DRX cycle with percentage of active time above the configured threshold within the configured period, information to request reporting the current temperature of the UE, information to request reporting the predicted holding time (the UE may have severe problem after this holding time, if the UE's temperature is not decreased), information to request reporting the severity of in-device coexistence (IDC) problem, a configured threshold used to calculate the severity of IDC problem, information to request reporting the interference measurement result related to IDC problem, information to request reporting the predicted throughput, information to request reporting the predicted delay requirement, information to request reporting the predicted time duration the UE will not send or receive data, information to request reporting the predicted remaining battery working time if the UE's preference will be adopted by the network, and/or information to request reporting the predicted remaining battery working time if the UE's preference will not be adopted by the network.

The first configuration information can include at least one of: information to request reporting the remaining battery working time, information to request reporting the percentage of remaining battery working time, information to request reporting the level of remaining battery working time, information to request reporting the estimated whole battery working time after 100% recharged, information to request reporting the average recharging interval of the UE, and/or information to request reporting the percentage of time that remaining battery working time is less than a threshold.

The first configuration information can include at least one of: a configured threshold used to calculate the percentage of time that remaining battery working time is less than the configured threshold, information to request reporting the UE capability information, information to request reporting the UE category, information to request reporting the UE type, e.g. normal UE, industry sensor, video surveillance, wearable device, information to request reporting the periodical measurement result per CLI-RSSI resource and CLI-RSSI resource index, information to request reporting the periodical reference signal received power (RSRP) measurement result per SRS resource and SRS resource index, information to request reporting the event triggered measurement result per CLI-RSSI resource and CLI-RSSI resource index, for example event I1 (Interference becomes higher than threshold) triggered, information to request reporting the event triggered RSRP measurement result per SRS resource and SRS resource index, for example event I1 (Interference becomes higher than threshold) triggered, a configured period used to report the periodical measurement result per CLI-RSSI resource or SRS resource, and/or a configured threshold used to report the event triggered measurement result per CLI-RSSI resource or SRS resource.

The first configuration information can be included in the existing radio resource control (RRC) reconfiguration message, the existing logged measurement configuration message, or a new message.

### Example Embodiment 1

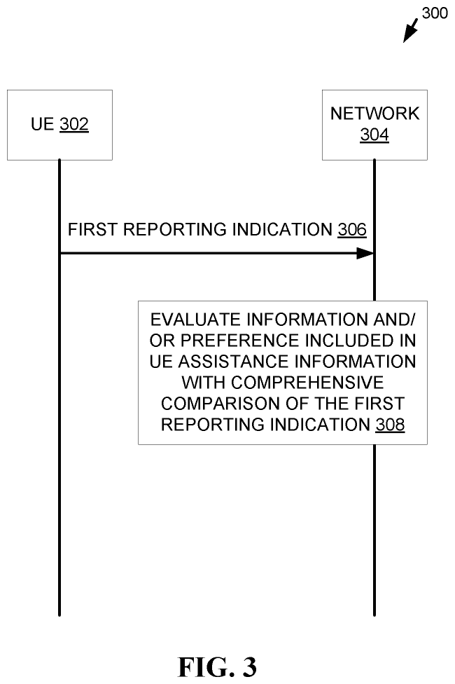

FIG. 3 is a signaling process 300 for valuating UE assistance information according to a first example embodiment.

At 306, a UE 302 can report to a network 304 a first reporting information. The first reporting information includes at least one of: an average scheduling interval including both downlink and uplink, an average downlink scheduling interval, an average uplink scheduling interval, a number of physical downlink control channel (PDCCH) reception per discontinuous reception (DRX) cycle or per configured period, an average percentage of active time in a DRX cycle, a number of continuous DRX cycle with percentage of active time above configured threshold, a number of DRX cycle with percentage of active time above configured threshold within configured period, current temperature of the UE, a predicted holding time (the UE may have severe problem after this holding time, if the UE's temperature is not decreased), a severity of in-device coexistence (IDC) problem, an interference measurement result related to IDC problem, a predicted throughput, a predicted delay requirement, a predicted time duration the UE will not send or receive data, a predicted remaining battery working time if the UE's preference will be adopted by the network, a predicted remaining battery working time if the UE's preference will not be adopted by the network, a remaining battery working time, a percentage of remaining battery working time, a level of remaining battery working time, for example high-medium-low, another example index 1, 2, . . . , 10 represents 10%, 20%, . . . , 100%, an estimated whole battery working time after 100% recharged, an average recharging interval of the UE, percentage of time that remaining battery working time is less than a configured threshold, a UE capability information, a UE category, a UE type, e.g. normal UE, industry sensor, video surveillance, wearable device, a periodical measurement result per cross link interference-received signal strength indication (CLI-RSSI) resource and CLI-RSSI resource index, a periodical measurement result per sounding reference signal (SRS) resource and SRS resource index, an event triggered measurement result per CLI-RSSI resource and CLI-RSSI resource index, for example event I1 (interference becomes higher than threshold) triggered, and/or an event triggered measurement result per SRS resource and SRS resource index, for example event I1 (interference becomes higher than threshold) triggered.

The first reporting information can be included in the existing UE assistance information message, the existing UE information response message, the existing measurement report message, or a new message.

At 308, the network 304 can evaluate the information and/or the preference included in the UE assistance information message received from the UE with comprehensive comparison of the first reporting information. For example, to evaluate whether the information and/or the preference included in the UE assistance information message is too aggressive or on the opposite.

### Example Embodiment 2

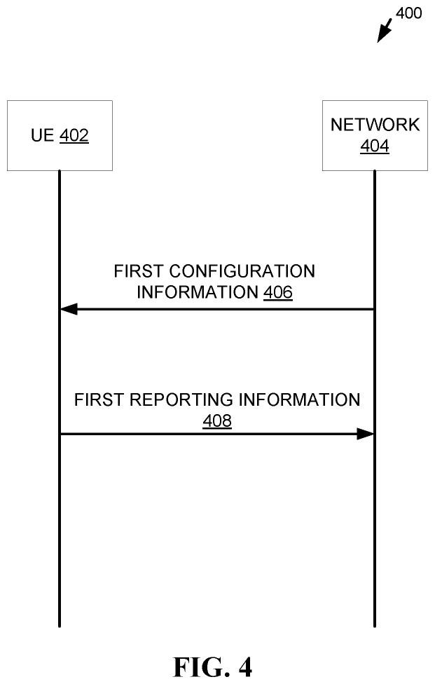

FIG. 4 is a signaling process 400 for valuating UE assistance information according to a second example embodiment.

At 406, a network 404 can send a first configuration information to a UE 402. The first configuration information can include at least one of: information to request reporting the average scheduling interval including both downlink and uplink, information to request reporting the average downlink scheduling interval, information to request reporting the average uplink scheduling interval, information to request reporting the number of PDCCH reception per DRX cycle or per configured period, a configured period used to calculate the number of PDCCH reception per the configured period, information to request reporting the average percentage of active time in a DRX cycle, and/or information to request reporting the number of continuous DRX cycle with percentage of active time above configured threshold.

The first configuration information can include at least one of: a configured threshold used to calculate the number of continuous DRX cycle with percentage of active time above the configured threshold, information to request reporting the number of DRX cycle with percentage of active time above configured threshold within configured period, a configured threshold and a configured period used to calculate the number of DRX cycle with percentage of active time above the configured threshold within the configured period, information to request reporting the current temperature of the UE, information to request reporting the predicted holding time (the UE may have severe problem after this holding time, if the UE's temperature is not decreased), information to request reporting the severity of in-device coexistence (IDC) problem, and/or a configured threshold used to calculate the severity of IDC problem.

The first configuration information can include at least one of: information to request reporting the interference measurement result related to IDC problem, information to request reporting the predicted throughput, information to request reporting the predicted delay requirement, information to request reporting the predicted time duration the UE will not send or receive data, information to request reporting the predicted remaining battery working time if the UE's preference will be adopted by the network, information to request reporting the predicted remaining battery working time if the UE's preference will not be adopted by the network, information to request reporting the remaining battery working time, information to request reporting the percentage of remaining battery working time, and/or information to request reporting the level of remaining battery working time.

The first configuration information can include at least one of: information to request reporting the estimated whole battery working time after 100% recharged, information to request reporting the average recharging interval of the UE, information to request reporting the percentage of time that remaining battery working time is less than a threshold, a configured threshold used to calculate the percentage of time that remaining battery working time is less than the configured threshold, information to request reporting the UE capability information, information to request reporting the UE category, information to request reporting the UE type, e.g. normal UE, industry sensor, video surveillance, wearable device, and/or information to request reporting the periodical measurement result per CLI-RSSI resource and CLI-RSSI resource index.

The first configuration information can include at least one of: information to request reporting the periodical measurement result per SRS resource and SRS resource index, information to request reporting the event triggered measurement result per CLI-RSSI resource and CLI-RSSI resource index, for example event I1 (Interference becomes higher than threshold) triggered, information to request reporting the event triggered measurement result per SRS resource and SRS resource index, for example event I1 (Interference becomes higher than threshold) triggered, a configured period used to report the periodical measurement result per CLI-RSSI resource or SRS resource, and/or a configured threshold used to report the event triggered measurement result per CLI-RSSI resource or SRS resource.

The first configuration information can be included in the existing radio resource control (RRC) reconfiguration message, the existing logged measurement configuration message, or a new message.

At 408, the UE 402 can report a first reporting information to the network 404 according to the received first configuration information.

### Example Embodiment 3

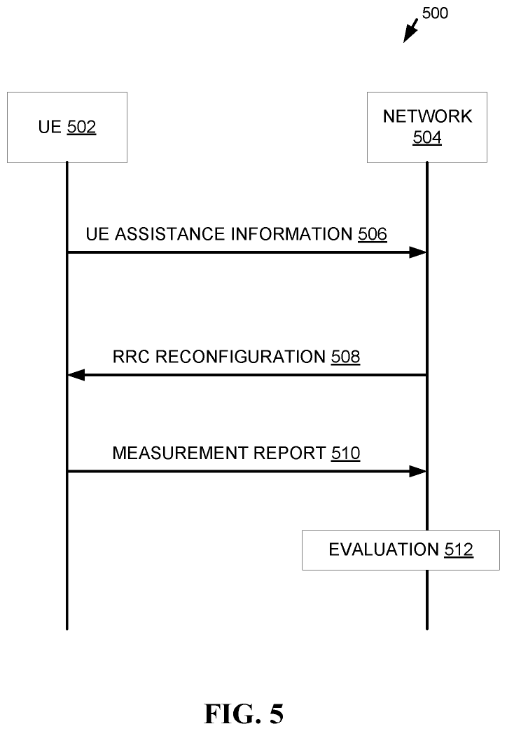

FIG. 5 is a signaling process 500 for valuating UE assistance information according to a third example embodiment.

At 506, the UE 502 can report a preference for power saving by the UE assistance information message.

At 508, the network 504 sends a first configuration information to the UE 502 by the radio resource control (RRC) reconfiguration message.

The first configuration information can include at least one of: information to request reporting the percentage of remaining battery working time, information to request reporting the estimated whole battery working time after 100% recharged, information to request reporting the average recharging interval of the UE, information to request reporting the percentage of time that remaining battery working time is less than a threshold, and/or a configured threshold (e.g. 20%) used to calculate the percentage of time that remaining battery working time is less than the configured threshold.

At 510, the UE 502 can report to the network 504 a first reporting information by the measurement report message, according to the received first configuration information, the first reporting information can include at least one of: a percentage of remaining battery working time, an estimated whole battery working time after 100% recharged, an average recharging interval of the UE, and/or a percentage of time that remaining battery working time is less than a configured threshold.

At 512, the network 504 can evaluate the received preference for power saving with comprehensive comparison of the received first reporting information. For example, the network may think the preference for power saving is too aggressive, since the first reporting information shows that the UE may be with a long remaining battery working time, may be recharged frequently and seldom with remaining battery working time less than 20%. The network may not adopt the preference for power saving from the UE or may take another way for power saving.

### Example Embodiment 4

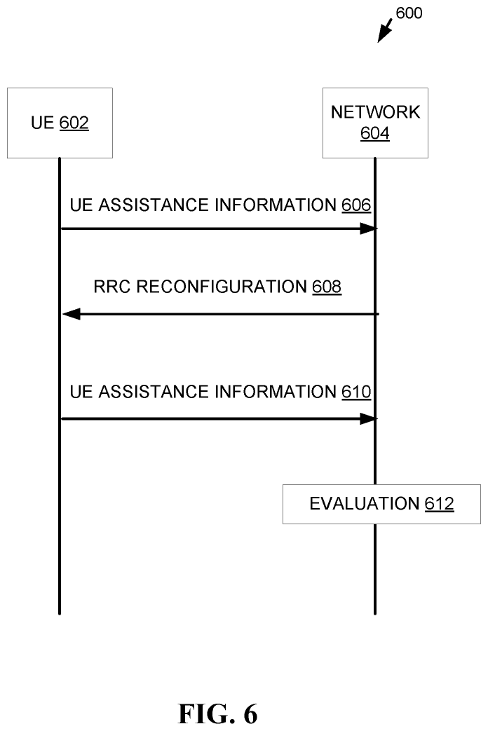

FIG. 6 is a signaling process 600 for valuating UE assistance information according to a fourth example embodiment. At 606, the UE 602 can report a preference of transition out of RRC_CONNECTED state by the UE assistance information message.

At 608, the network 604 can send a first configuration information to the UE by the radio resource control (RRC) reconfiguration message, the first configuration information can include at least one of: information to request reporting the predicted time duration the UE will not send or receive data, information to request reporting the percentage of remaining battery working time, and/or information to request reporting the estimated whole battery working time after 100% recharged.

At 610, the UE 602 can report to the network a first reporting information by the UE assistance information message, according to the received first configuration information, the first reporting information can include at least one of: a predicted time duration the UE will not send or receive data, a percentage of remaining battery working time, and an estimated whole battery working time after 100% recharged.

At 612, the network 604 can evaluate the received preference of transition out of RRC_CONNECTED state with comprehensive comparison of the received first reporting information. For example, the network may think the preference of transition out of RRC_CONNECTED state is too aggressive, since the first reporting information shows that the UE may be with a long remaining battery working time and the predicted time duration the UE will not send or receive data is short. The network may not adopt the preference of transition out of RRC_CONNECTED state from the UE.

### Example Embodiment 5

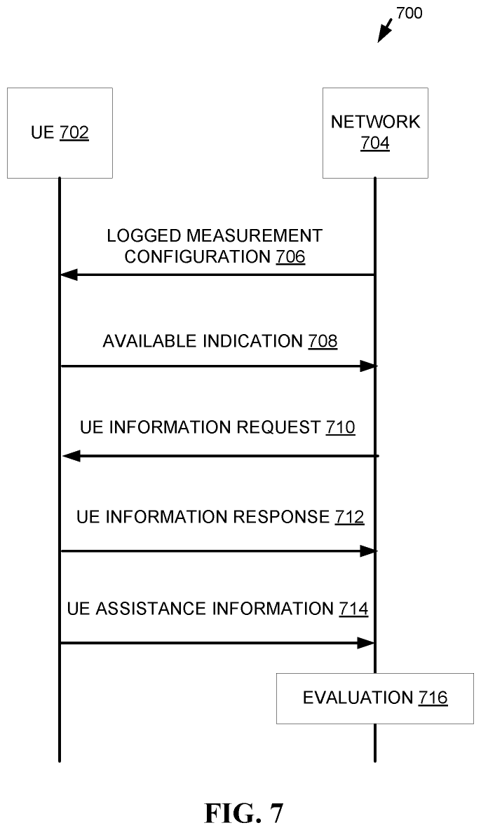

FIG. 7 is a signaling process 700 for valuating UE assistance information according to a fifth example embodiment. At 706, the network 702 can send a first configuration information to the UE by the logged measurement configuration message, the first configuration information can include at least one of: information to request reporting the percentage of remaining battery working time, information to request reporting the estimated whole battery working time after 100% recharged, information to request reporting the average recharging interval of the UE, information to request reporting the percentage of time that remaining battery working time is less than a threshold, and/or a configured threshold (e.g. 20%) used to calculate the percentage of time that remaining battery working time is less than the configured threshold.

At 708, the UE 702 can send to the network an available indication of a first reporting information included in the RRCResumeComplete message, RRCReestablishmentComplete message, RRCReconfigurationComplete message, or RRCSetupComplete message message.

At 710, the network 704 can send to the UE 702 a request indication for the first reporting information by the UE information request message.

At 712, the UE 702 can report to the network the first reporting information by the UE information response message according to the UE information request message. The first reporting information can include at least one of: a percentage of remaining battery working time, an estimated whole battery working time after 100% recharged, an average recharging interval of the UE, and/or a percentage of time that remaining battery working time is less than a configured threshold.

At 714, the UE 702 can report a preference for power saving by the UE assistance information message.

At 716, the network 704 can evaluate the received preference for power saving with comprehensive comparison of the received first reporting information. For example, the network may think the preference for power saving is too aggressive, since the first reporting information shows that the UE may be with a long remaining battery working time, may be recharged frequently and seldom with remaining battery working time less than 20%. The network may not adopt the preference for power saving from the UE or may take a more smooth way for power saving.

### Example Embodiment 6

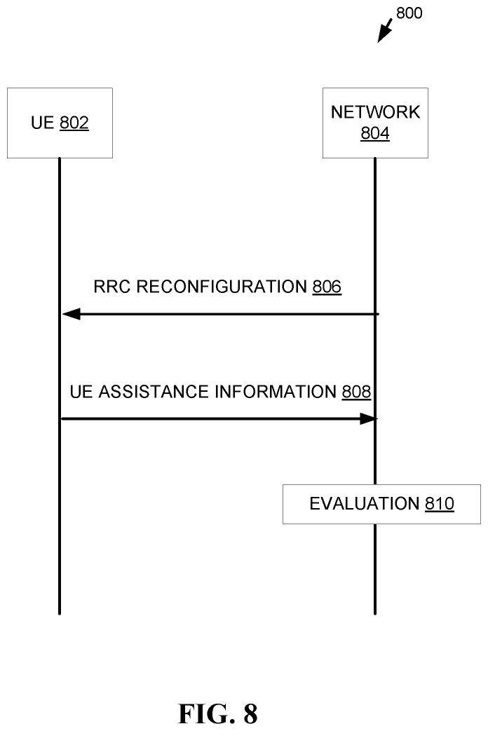

FIG. 8 is a signaling process 800 for valuating UE assistance information according to a sixth example embodiment.

At 806, the network 804 can send a first configuration information to the UE by the radio resource control (RRC) reconfiguration message, the first configuration information can include at least one of: information to request reporting the preference of transition out of RRC_CONNECTED state, information to request reporting the predicted time duration the UE will not send or receive data, information to request reporting the percentage of remaining battery working time, and/or information to request reporting the estimated whole battery working time after 100% recharged.

At 808, the UE 802 can report to the network a first reporting information by the UE assistance information message, according to the received first configuration information, the first reporting information can include at least one of: preference of transition out of RRC_CONNECTED state, predicted time duration the UE will not send or receive data, percentage of remaining battery working time, and/or an estimated whole battery working time after 100% recharged.

At 810, the network 804 can evaluate the received preference of transition out of RRC_CONNECTED state with comprehensive comparison of the received first reporting information. For example, the network may think the preference of transition out of RRC_CONNECTED state is too aggressive, since the first reporting information shows that the UE may be with a long remaining battery working time and the predicted time duration the UE will not send or receive data is short. The network may not adopt the preference of transition out of RRC_CONNECTED state from the UE.

### Example Embodiment 7

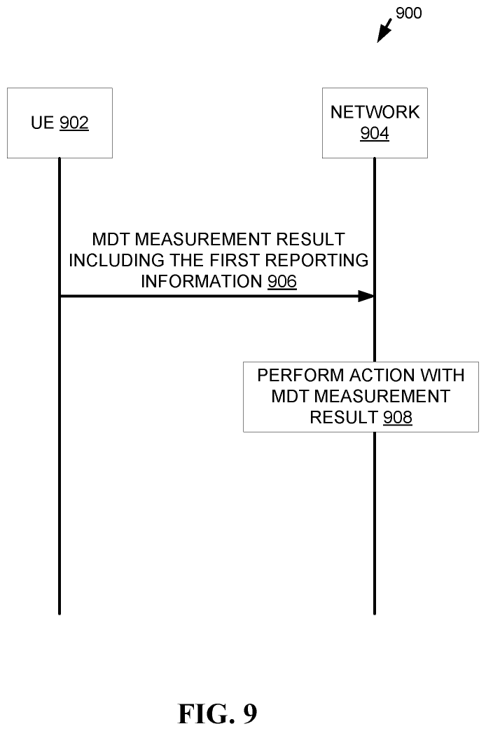

FIG. 9 is a signaling process 900 for minimization of driving test or self-optimizing network according to a seventh example embodiment.

At 906, the UE 902 can report to a network a first reporting information for minimization of driving test (MDT) purpose (i.e. the first reporting information is or is partial of the MDT measurement result) or for self-optimizing network (SON) purpose. The first reporting information can include at least one of: UE capability information, UE category, UE type, e.g. normal UE, industry sensor, video surveillance, wearable device, periodical measurement result per cross link interference-received signal strength indication (CLI-RSSI) resource and CLI-RSSI resource index, periodical reference signal received power (RSRP) measurement result per sounding reference signal (SRS) resource and SRS resource index, event triggered measurement result per CLI-RSSI resource and CLI-RSSI resource index, for example event I1 (interference becomes higher than threshold) triggered, event triggered RSRP measurement result per SRS resource and SRS resource index, for example event I1 (interference becomes higher than threshold) triggered, preamble group indication to indicate whether preamble group A or preamble group B is used (The indication can be per each random access RA procedure or per each RA attempt of RA procedure. The indication can be a one-bit indication, where value “0” can indicate preamble group A and value “1” for preamble group B, or vice versa. Alternatively, the indication can be enumerated from group A or group B. Alternatively, the indication can be a presence of group B, presence of the indication means for preamble group B, absence of the indication means for preamble group A), physical uplink shared channel PUSCH group indication to indicate whether PUSCH configuration is for preamble group A or for preamble group B (The indication can be per each RA procedure or per each RA attempt of RA procedure.

The indication can be a one bit indication, wherein value “0” can indicate PUSCH configuration for preamble group A and value “1” for preamble group B, or vice versa. Or, the indication can be enumerated from group A or group B. Alternatively, the indication can be a presence of group B, presence of the indication means PUSCH configuration for preamble group B, absence of the indication means for preamble group A. Alternatively, the indication can be derived from the preamble group indication, if the preamble group indication indicates preamble group A is used, accordingly PUSCH configuration for preamble group A is used, otherwise preamble group B is used), number of preamble sent per cell for 4-step RA (or type 1 RA), number of preamble sent per beam per cell for 4-step RA (or type 1 RA), number of preamble sent per cell for 2-step RA (or type 2 RA), number of preamble sent per beam per cell for 2-step RA (or type 2 RA), and/or a MsgA PUSCH information used to specify the PUSCH resource allocation for MsgA in 2-step RA.

The MsgA PUSCH information can include at least one of: an nID, Offset of lowest PUSCH occasion in frequency domain with respect to PRB 0 (frequencyStartMsgA-PUSCH), Value of hopping bits to indicate which frequency offset to be used for second hop (msgA-HoppingBits), Intra-slot frequency hopping per PUSCH occasion (msgA-IntraSlotFrequencyHopping), a combination of start symbol and length and PUSCH mapping type from the TDRA table (msgA-PUSCH-TimeDomainAllocation), a single time offset with respect to the start of each PRACH slot (msgA-PUSCH-TimeDomainOffset) counted as the number of slots, a number of msgA PUSCH occasions FDMed in one time instance (nrofMsgA-PO-FDM), a number of time domain PUSCH occasions in each slot (nrofMsgA-PO-PerSlot), a number of PRBs per PUSCH occasion (nrofPRBs-PerMsgA-PO), a number of slots containing one or multiple PUSCH occasions (nrofSlotsMsgA-PUSCH), and/or an index giving valid combinations of start symbol, length and mapping type as start and length indicator for the first msgA PUSCH occasion (startSymbolAndLengthMsgA-PO).

The first reporting information can be included in the existing UE information response message, the existing measurement report message, or a new message.

At 908, the network 904 can deal with the MDT measurement result. For example, the network may aggregate the MDT measurement result per UE category according to the received UE category. As another example, the network may can better reduce the cross link interference based on the CLI-RSSI and/or SRS-RSRP measurement result of the first reporting information of MDT measurement result.

### Example Embodiment 8

A network node can calculate at least one of: number of received random access preambles per cell for 4-step, number of received random access preambles per cell for 2-step, number of received random access preambles per synchronization signal and physical broadcast channel block (SSB) per cell for 4-step, number of received random access preambles per SSB per cell for 2-step, number of resume request received per cell, and/or number of resume request received per RAN notification area, and sends the calculation result(s) to a trace collection entity TCE.

### Example Embodiment 9

A network node can receive a configuration information from a core network node or a OAM (operation and maintenance) node, the configuration information can include at least one of: information to request reporting number of received random access preambles per cell for 4-step, information to request reporting number of received random access preambles per cell for 2-step, information to request reporting number of received random access preambles per SSB per cell for 4-step, information to request reporting number of received random access preambles per SSB per cell for 2-step, information to request reporting number of resume request received per cell, and/or information to request reporting number of resume request received per RAN notification area, and performs calculation according to the configuration information.

### Example Embodiment 10

A network node can send a measurement result to another network node. The measurement result can include a UE assistance information received from a terminal and/or a updated UE assistance information sent to the terminal. The UE assistance information can include at least one of: delay budget report carrying desired increment/decrement in the connected mode DRX cycle length, overheating assistance information, IDC assistance information, preference on DRX parameters for power saving, preference on the maximum aggregated bandwidth for power saving, preference on the maximum number of secondary component carriers for power saving, preference on the maximum number of MIMO (multiple in multiple out) layers for power saving, preference on the minimum scheduling offset for cross-slot scheduling for power saving, assistance information to transition out of RRC_CONNECTED state when the UE does not expect to send or receive data in the near future, UE capability ID to identify the category, type or model of the terminal (the UE capability ID can be a vendor ID to identify the vendor of the terminal), and/or configured grant assistance for NR sidelink communication.

Elements of the UE assistance information that need to be sent to another network with the measurement result can be configured by a core network node or OAM node, or specified.

### Example Embodiment 11

A terminal can send a measurement result to a network node. The measurement result can include a UE assistance information reported to the network node and/or a updated UE assistance information received from the network node. The UE assistance information can include at least one of: delay budget report carrying desired increment/decrement in the connected mode DRX cycle length, overheating assistance information, IDC assistance information, preference on DRX parameters for power saving, preference on the maximum aggregated bandwidth for power saving, preference on the maximum number of secondary component carriers for power saving, preference on the maximum number of MIMO (multiple in multiple out) layers for power saving, preference on the minimum scheduling offset for cross-slot scheduling for power saving, assistance information to transition out of RRC_CONNECTED state when the UE does not expect to send or receive data in the near future, UE capability ID to identify the category, type or model of the terminal (the UE capability ID can be a vendor ID to identify the vendor of the terminal), and/or configured grant assistance for NR sidelink communication.

Elements of the UE assistance information that may need to be sent to the network node with the measurement result can be configured by the network node or specified.

### Example Embodiment 12

A network node can send a measurement result to another network node including an indication that the measurement result may be invalid, or the network node does not send the measurement result to another network node, according to a UE assistance information received from a terminal and/or a updated UE assistance information sent to the terminal. The UE assistance information can include at least one of: delay budget report carrying desired increment/decrement in the connected mode DRX cycle length, overheating assistance information, IDC assistance information, preference on DRX parameters for power saving, preference on the maximum aggregated bandwidth for power saving, preference on the maximum number of secondary component carriers for power saving, preference on the maximum number of MIMO (multiple in multiple out) layers for power saving, preference on the minimum scheduling offset for cross-slot scheduling for power saving, assistance information to transition out of RRC_CONNECTED state when the UE does not expect to send or receive data in the near future, UE capability ID to identify the category, type or model of the terminal (the UE capability ID can be a vendor ID to identify the vendor of the terminal), and/or configured grant assistance for NR sidelink communication.

Elements of the UE assistance information that may need to be regarded to determine whether to send the measurement result to the another network node including the indication that the measurement result may be invalid, or the network node does not send the measurement result to the another network node, can be configured by a core network node or OAM node, or specified.

### Example Embodiment 13

A terminal can send a measurement result to a network node including an indication that the measurement result may be invalid, or the terminal does not send the measurement result to the network node, according to a UE assistance information reported to the network node and/or a updated UE assistance information received from the network node. The UE assistance information can include at least one of: delay budget report carrying desired increment/decrement in the connected mode DRX cycle length, overheating assistance information, IDC assistance information, preference on DRX parameters for power saving, preference on the maximum aggregated bandwidth for power saving, preference on the maximum number of secondary component carriers for power saving, preference on the maximum number of MIMO (multiple in multiple out) layers for power saving, preference on the minimum scheduling offset for cross-slot scheduling for power saving, assistance information to transition out of RRC_CONNECTED state when the UE does not expect to send or receive data in the near future, UE capability ID to identify the category, type or model of the terminal (the UE capability ID can be a vendor ID to identify the vendor of the terminal), and/or configured grant assistance for NR sidelink communication.

Elements of the UE assistance information that may need to be regarded to determine whether to send the measurement result to the network node including the indication that the measurement result may be invalid, or the terminal does not send the measurement result to the network node, can be configured by the network node, or specified.

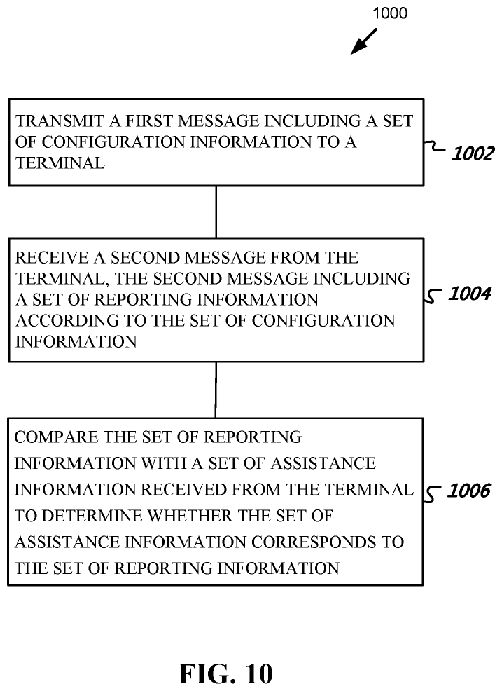

FIG. 10 is a block diagram of an example method 1000 for valuation of UE assistance information. The method can include transmitting, by a network node, a first message including a set of configuration information to a terminal (block 1002). The first message can include an RRC reconfiguration message as discussed in FIG. 5, 6, or 8, for example.

The method can also include receiving, by the network node, a second message from the terminal, the second message including a set of reporting information according to the set of configuration information (block 1004). The second message can include a first reporting information message as described in FIG. 4 or a measurement report as described with respect to FIG. 5, for example.

The method can also include comparing, by the network node, the set of reporting information with a set of assistance information received from the terminal to determine whether the set of assistance information corresponds to the set of reporting information (block 1006). This can include evaluating the set of reporting information as described with respect to FIGS. 5-8, for example.

In another embodiment, a method for wireless communication can include transmitting, by a network node, a first message including a set of configuration information to a terminal. The method can also include receiving, by the network node, a second message from the terminal, the second message including a set of reporting information according to the set of configuration information. The method can also include deriving, by the network node, a minimization of driving test (MDT) measurement based on the set of reporting information.

In some embodiments, wherein the set of assistance information is received either before the second message or after the second message.

In some embodiments, the set of assistance information is included in the second message.

In some embodiments, the set of reporting information includes at least one of: an average scheduling interval for both downlink transmissions and uplink transmissions, an average downlink scheduling interval, an average uplink scheduling interval, a number of physical downlink control channel (PDCCH) receptions per a discontinuous reception (DRX) cycle or per a configured period, an average percentage of an active time in a DRX cycle, a number of continuous DRX cycles with a percentage of active time above a configured threshold, and/or a number of DRX cycles with the percentage of active time above the configured threshold within a configured period.

In some embodiments, the set of reporting information includes at least one of: a current temperature of the terminal, a predicted holding time, a severity of an in-device coexistence (IDC), an interference measurement result related to IDC, a predicted throughput, a predicted delay requirement, and/or a predicted time duration the terminal will not send or receive data.

In some embodiments, the set of reporting information includes at least one of: a predicted remaining battery working time if the parameter is adopted by the network, a predicted remaining battery working time if the parameter is not adopted by the network, a remaining battery working time, a percentage of remaining battery working time, a level of remaining battery working time, an estimated whole battery working time after being fully recharged, an average recharging interval of the terminal, and/or a percentage of time that remaining battery working time is less than a configured threshold.

In some embodiments, the set of reporting information includes at least one of: a terminal capability information, a terminal category, a terminal type, a periodic measurement result per cross link interference-received signal strength indication CLI-RSSI resource and CLI-RSSI resource index, a periodic reference signal received power RSRP measurement result per sounding reference signal SRS resource and SRS resource index, an event triggered measurement result per CLI-RSSI resource and CLI-RSSI resource index, and/or an event triggered RSRP measurement result per SRS resource and SRS resource index.

In some embodiments, the set of reporting information is included in any of a UE assistance information message, a UE information response message, and/or a measurement report message.

In some embodiments, the set of configuration information includes any of: information to request reporting an average scheduling interval including both downlink transmissions and uplink transmissions, information to request reporting an average downlink scheduling interval, information to request reporting an average uplink scheduling interval, information to request reporting a number of PDCCH receptions per a DRX cycle or per a configured period, and/or a configured period used to calculate the number of PDCCH receptions per configured period.

In some embodiments, the set of configuration information includes any of: information to request reporting the average percentage of active time in a DRX cycle, information to request reporting a number of continuous DRX cycles with a percentage of active time above a configured threshold, a configured threshold used to calculate the number of continuous DRX cycles with the percentage of active time above the configured threshold, information to request reporting a number of DRX cycles with a percentage of active time above the configured threshold within a configured period, and/or the configured threshold and the configured period used to calculate the number of DRX cycles with the percentage of active time above the configured threshold within the configured period.

In some embodiments, the set of configuration information includes any of: information to request reporting a current temperature of the terminal, information to request reporting a predicted holding time, information to request reporting a severity of in-device coexistence (IDC), a configured threshold used to calculate the severity of IDC, and/or information to request reporting an interference measurement result related to IDC.

In some embodiments, the set of configuration information includes any of: information to request reporting a predicted throughput, information to request reporting a predicted delay requirement, and/or information to request reporting a predicted time duration that terminal will not send or receive data.

In some embodiments, the set of configuration information includes any of: information to request reporting a predicted remaining battery working time if a preference from the terminal is to be adopted by the network node, information to request reporting the predicted remaining battery working time if the preference from the terminal is not to be adopted by the network node, information to request reporting a remaining battery working time, information to request reporting a percentage of remaining battery working time, information to request reporting a level of remaining battery working time, information to request reporting an estimated whole battery working time after being fully recharged, and/or information to request reporting an average recharging interval of the terminal.

In some embodiments, the set of configuration information includes any of: information to request reporting a percentage of time that remaining battery working time is less than a threshold, a configured threshold used to calculate the percentage of time that remaining battery working time is less than the configured threshold, information to request reporting terminal capability information, information to request reporting a terminal category, and/or information to request reporting a terminal type.

In some embodiments, the set of configuration information includes any of: information to request reporting a periodic measurement result per CLI-RSSI resource and CLI-RSSI resource index, information to request reporting a periodic reference signal received power RSRP measurement result per SRS resource and SRS resource index, information to request reporting an event triggered measurement result per CLI-RSSI resource and CLI-RSSI resource index, information to request reporting an event triggered RSRP measurement result per SRS resource and SRS resource index, a configured period used to report the periodic measurement result per CLI-RSSI resource or SRS resource, and/or a configured threshold used to report an event triggered measurement result per CLI-RSSI resource or SRS resource.

In some embodiments, the first message includes any of a radio resource control (RRC) reconfiguration message and a logged measurement configuration message.

In some embodiments, the third message includes a UE assistance information message.

### Example Wireless System

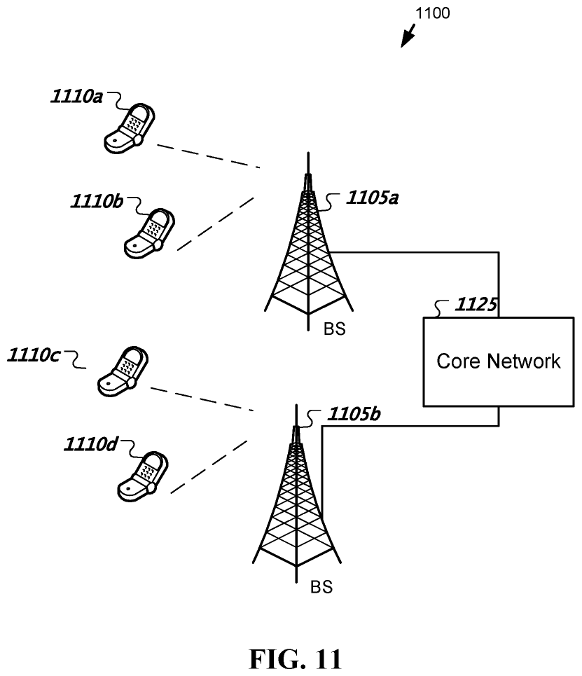

FIG. 11 shows an example of a wireless communication system where techniques in accordance with one or more embodiments of the present technology can be applied. A wireless communication system 1100 can include one or more base stations (BSs) 1105a, 1105b, one or more wireless devices or terminals 1110a, 1110b, 1110c, 1110d, and a core network 1125. A base station 1105a, 1105b can provide wireless service to wireless devices 1110a, 1110b, 1110c and 1110d in one or more wireless sectors. In some implementations, a base station 1105a, 1105b includes directional antennas to produce two or more directional beams to provide wireless coverage in different sectors. The base station may implement functionalities of a scheduling cell or a candidate cell, as described in the present document.

The core network 1125 can communicate with one or more base stations 1105a, 1105b. The core network 1125 provides connectivity with other wireless communication systems and wired communication systems. The core network may include one or more service subscription databases to store information related to the subscribed wireless devices 1110a, 1110b, 1110c, and 1110d. A first base station 1105a can provide wireless service based on a first radio access technology, whereas a second base station 1105b can provide wireless service based on a second radio access technology. The base stations 1105a and 1105b may be co-located or may be separately installed in the field according to the deployment scenario. The wireless devices 1110a, 1110b, 1110c, and 1110d can support multiple different radio access technologies.

In some implementations, a wireless communication system can include multiple networks using different wireless technologies. A dual-mode or multi-mode wireless device includes two or more wireless technologies that could be used to connect to different wireless networks.

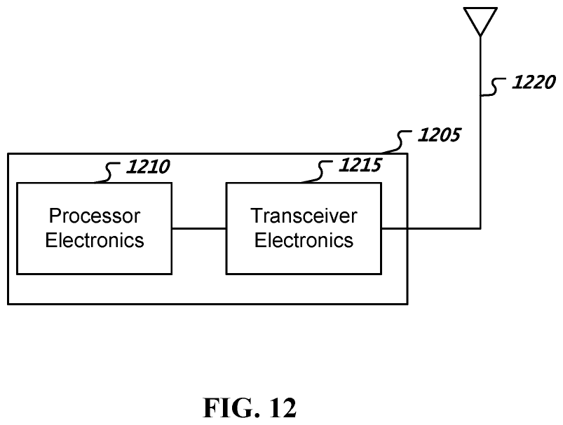

FIG. 12 is a block diagram representation of a portion of a hardware platform. A hardware platform 1205 such as a network node or a base station or a terminal or a wireless device (or UE) can include processor electronics 1210 such as a microprocessor that implements one or more of the techniques presented in this document. The hardware platform 1205 can include transceiver electronics 1215 to send and/or receive wired or wireless signals over one or more communication interfaces such as antenna 1220 or a wireline interface. The hardware platform 1205 can implement other communication interfaces with defined protocols for transmitting and receiving data. The hardware platform 1205 can include one or more memories (not explicitly shown) configured to store information such as data and/or instructions. In some implementations, the processor electronics 1210 can include at least a portion of the transceiver electronics 1215. In some embodiments, at least some of the disclosed techniques, modules or functions are implemented using the hardware platform 1205.

### CONCLUSION

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
transmitting, by a network node, a first message including a set of configuration information to a terminal;
receiving, by the network node, a second message from the terminal, the second message including a set of reporting information according to the set of configuration information; and
comparing, by the network node, the set of reporting information with a set of assistance information received from the terminal included in a third message, to determine whether the set of assistance information corresponds to the set of reporting information.

2. The method of claim 1, wherein the set of assistance information is included in the second message.

3. The method of claim 1, wherein the set of reporting information includes at least one of: an average scheduling interval for both downlink transmissions and uplink transmissions, an average downlink scheduling interval, an average uplink scheduling interval, a number of physical downlink control channel (PDCCH) receptions per a discontinuous reception (DRX) cycle or per a configured period, an average percentage of an active time in a DRX cycle, a number of continuous DRX cycles with a percentage of active time above a configured threshold, and/or a number of DRX cycles with the percentage of active time above the configured threshold within a configured period, a current temperature of the terminal, a predicted holding time, a severity of an in-device coexistence (DC), an interference measurement result related to DC, a predicted throughput, a predicted delay requirement, and/or a predicted time duration the terminal will not send or receive data, a predicted remaining battery working time if the parameter is adopted by the network, a predicted remaining battery working time if the parameter is not adopted by the network, a remaining battery working time, a percentage of remaining battery working time, a level of remaining battery working time, an estimated whole battery working time after being fully recharged, an average recharging interval of the terminal, and/or a percentage of time that remaining battery working time is less than a configured threshold.

4. The method of claim 1, wherein the set of reporting information includes at least one of: a terminal capability information, a terminal category, a terminal type, a periodic measurement result per cross link interference-received signal strength indication CLI-RSSI resource and CLI-RSSI resource index, a periodic reference signal received power RSRP measurement result per sounding reference signal SRS resource and SRS resource index, an event triggered measurement result per CLI-RSSI resource and CLI-RSSI resource index, an event triggered RSRP measurement result per SRS resource and SRS resource index, a preamble group indication, a PUSCH group indication, number of preamble sent per cell for 4-step RA, number of preamble sent per beam per cell for 4-step RA, number of preamble sent per cell for 2-step RA, number of preamble sent per beam per cell for 2-step RA, and/or a MsgA PUSCH information.

5. The method of claim 1, wherein the set of reporting information is included in any of a UE assistance information message, a UE information response message, and/or a measurement report message.

6. The method of claim 1, wherein the set of configuration information includes any of: information to request reporting an average scheduling interval including both downlink transmissions and uplink transmissions, information to request reporting an average downlink scheduling interval, information to request reporting an average uplink scheduling interval, information to request reporting a number of PDCCH receptions per a DRX cycle or per a configured period, and/or a configured period used to calculate the number of PDCCH receptions per configured period.

7. The method of claim 1, wherein the set of configuration information includes any of: information to request reporting an average percentage of active time in a DRX cycle, information to request reporting a number of continuous DRX cycles with a percentage of active time above a configured threshold, a configured threshold used to calculate the number of continuous DRX cycles with the percentage of active time above the configured threshold, information to request reporting a number of DRX cycles with a percentage of active time above the configured threshold within a configured period, and/or the configured threshold and the configured period used to calculate the number of DRX cycles with the percentage of active time above the configured threshold within the configured period.

8. The method of claim 1, wherein the set of configuration information includes any of: information to request reporting a current temperature of the terminal, information to request reporting a predicted holding time, information to request reporting a severity of in-device coexistence (IDC), a configured threshold used to calculate the severity of IDC, and/or information to request reporting an interference measurement result related to IDC, information to request reporting a predicted throughput, information to request reporting a predicted delay requirement, and/or information to request reporting a predicted time duration that terminal will not send or receive data, information to request reporting a predicted remaining battery working time if a preference from the terminal is to be adopted by the network node, information to request reporting the predicted remaining battery working time if the preference from the terminal is not to be adopted by the network node, information to request reporting a remaining battery working time, information to request reporting a percentage of remaining battery working time, information to request reporting a level of remaining battery working time, information to request reporting an estimated whole battery working time after being fully recharged, and/or information to request reporting an average recharging interval of the terminal, information to request reporting a percentage of time that remaining battery working time is less than a threshold, a configured threshold used to calculate the percentage of time that remaining battery working time is less than the configured threshold, information to request reporting terminal capability information, information to request reporting a terminal category, and/or information to request reporting a terminal type.

9. The method of claim 1, wherein the set of configuration information includes any of: information to request reporting a percentage of time that remaining battery working time is less than a threshold, a configured threshold used to calculate the percentage of time that remaining battery working time is less than the configured threshold, information to request reporting terminal capability information, information to request reporting a terminal category, and/or information to request reporting a terminal type, information to request reporting a periodic measurement result per CLI-RSSI resource and CLI-RSSI resource index, information to request reporting a periodic reference signal received power RSRP measurement result per SRS resource and SRS resource index, information to request reporting an event triggered measurement result per CLI-RSSI resource and CLI-RSSI resource index, information to request reporting an event triggered RSRP measurement result per SRS resource and SRS resource index, a configured period used to report the periodic measurement result per CLI-RSSI resource or SRS resource, and/or a configured threshold used to report an event triggered measurement result per CLI-RSSI resource or SRS resource.

10. The method of claim 1, wherein the first message includes any of a radio resource control (RRC) reconfiguration message and a logged measurement configuration message.

11. The method of claim 1, wherein the third message includes a UE assistance information message.

12. A method for wireless communication, comprising:
transmitting, by a network node, a first message including a set of configuration information to a terminal;
receiving, by the network node, a second message from the terminal, the second message including a set of reporting information according to the set of configuration information; and
deriving, by the network node, a minimization of driving test (MDT) measurement based on the set of reporting information.

13. The method of claim 12, wherein the set of reporting information includes at least one of: an average scheduling interval for both downlink transmissions and uplink transmissions, an average downlink scheduling interval, an average uplink scheduling interval, a number of physical downlink control channel (PDCCH) receptions per a discontinuous reception (DRX) cycle or per a configured period, an average percentage of an active time in a DRX cycle, a number of continuous DRX cycles with a percentage of active time above a configured threshold, and/or a number of DRX cycles with the percentage of active time above the configured threshold within a configured period,

14. The method of claim 12, wherein the set of reporting information includes at least one of: a current temperature of the terminal, a predicted holding time, a severity of an in-device coexistence (IDC), an interference measurement result related to IDC, a predicted throughput, a predicted delay requirement, and/or a predicted time duration the terminal will not send or receive data, a predicted remaining battery working time if a parameter is adopted by the network, a predicted remaining battery working time if the parameter is not adopted by the network, a remaining battery working time, a percentage of remaining battery working time, a level of remaining battery working time, an estimated whole battery working time after being fully recharged, an average recharging interval of the terminal, and/or a percentage of time that remaining battery working time is less than a configured threshold.

15. The method of claim 12, wherein the set of reporting information includes at least one of: a terminal capability information, a terminal category, a terminal type, a periodic measurement result per cross link interference-received signal strength indication CLI-RSSI resource and CLI-RSSI resource index, a periodic reference signal received power RSRP measurement result per sounding reference signal SRS resource and SRS resource index, an event triggered measurement result per CLI-RSSI resource and CLI-RSSI resource index, an event triggered RSRP measurement result per SRS resource and SRS resource index, a preamble group indication, a PUSCH group indication, number of preamble sent per cell for 4-step RA, number of preamble sent per beam per cell for 4-step RA, number of preamble sent per cell for 2-step RA, number of preamble sent per beam per cell for 2-step RA, and/or a MsgA PUSCH information.

16. The method of claim 12, wherein the set of reporting information is included in any of a UE assistance information message, a UE information response message, and/or a measurement report message.

17. The method of claim 12, wherein the set of configuration information includes any of: information to request reporting an average scheduling interval including both downlink transmissions and uplink transmissions, information to request reporting an average downlink scheduling interval, information to request reporting an average uplink scheduling interval, information to request reporting a number of PDCCH receptions per a DRX cycle or per a configured period, and/or a configured period used to calculate the number of PDCCH receptions per configured period.

18. The method of claim 12, wherein the set of configuration information includes any of: information to request reporting an average percentage of active time in a DRX cycle, information to request reporting a number of continuous DRX cycles with a percentage of active time above a configured threshold, a configured threshold used to calculate the number of continuous DRX cycles with the percentage of active time above the configured threshold, information to request reporting a number of DRX cycles with a percentage of active time above the configured threshold within a configured period, and/or the configured threshold and the configured period used to calculate the number of DRX cycles with the percentage of active time above the configured threshold within the configured period.

19. The method of claim 12, wherein the set of configuration information includes any of: information to request reporting a current temperature of the terminal, information to request reporting a predicted holding time, information to request reporting a severity of in-device coexistence (IDC), a configured threshold used to calculate the severity of IDC, and/or information to request reporting an interference measurement result related to IDC, information to request reporting a predicted throughput, information to request reporting a predicted delay requirement, and/or information to request reporting a predicted time duration that terminal will not send or receive data, information to request reporting a predicted remaining battery working time if a preference from the terminal is to be adopted by the network node, information to request reporting the predicted remaining battery working time if the preference from the terminal is not to be adopted by the network node, information to request reporting a remaining battery working time, information to request reporting a percentage of remaining battery working time, information to request reporting a level of remaining battery working time, information to request reporting an estimated whole battery working time after being fully recharged, and/or information to request reporting an average recharging interval of the terminal, information to request reporting a percentage of time that remaining battery working time is less than a threshold, a configured threshold used to calculate the percentage of time that remaining battery working time is less than the configured threshold, information to request reporting terminal capability information, information to request reporting a terminal category, and/or information to request reporting a terminal type.

20. The method of claim 12, wherein the set of configuration information includes any of: information to request reporting a percentage of time that remaining battery working time is less than a threshold, a configured threshold used to calculate the percentage of time that remaining battery working time is less than the configured threshold, information to request reporting terminal capability information, information to request reporting a terminal category, and/or information to request reporting a terminal type, information to request reporting a periodic measurement result per CLI-RSSI resource and CLI-RSSI resource index, information to request reporting a periodic reference signal received power RSRP measurement result per SRS resource and SRS resource index, information to request reporting an event triggered measurement result per CLI-RSSI resource and CLI-RSSI resource index, information to request reporting an event triggered RSRP measurement result per SRS resource and SRS resource index, a configured period used to report the periodic measurement result per CLI-RSSI resource or SRS resource, and/or a configured threshold used to report an event triggered measurement result per CLI-RSSI resource or SRS resource.
